(19) United States
(12) Patent Application Publication
(10) Pub. No.: US 2012/0063264 A1
(43) Pub. Date: Mar. 15, 2012

(54) Method for the Emplacement of a Sensor in Soil for Sensing Seismic Activity

(75) Inventors: Theodore J. Vornbrock, Stevensville, MD (US); Aaron M. Foulk, Woodbridge, VA (US); Aaron A. Renner, Washington, DC (US); Nelson A. Gomez, Stafford, VA (US); Mark W. Olender, Alexandria, VA (US); Michael L. Millspaugh, Burke, VA (US)

(73) Assignee: Raytheon Company, Waltham, MA (US)

(21) Appl. No.: 12/878,929

(22) Filed: Sep. 9, 2010

(51) Int. Cl. G01V 1/00

(52) U.S. Cl. 367/41

(57) ABSTRACT

A method for the emplacement of a sensor in soil for sensing seismic activity comprising in one embodiment the steps of creating a borepath in the soil, the borepath having opposing ends and a diameter, inserting a longitudinal housing and a grout pipe into the borepath extending from one of said opposing ends to the other, the longitudinal housing having the sensor encapsulated within, the grout pipe having one end and a grouting end, pulling the grout pipe longitudinally within the borepath by the one end to position the grouting end between the opposing ends within the borepath, and conducting a grout through the grout pipe into the borepath at the grouting end to encase the longitudinal housing within the borepath thereby facilitating emplacement of a sensor in soil for sensing seismic activity. The grout preferably selected so to acoustically match the longitudinal housing to the soil.

### TECHNICAL FIELD OF THE DISCLOSURE

This disclosure relates generally to the sensing of seismic activity. More particularly, this disclosure relates to a method for the emplacement of a sensor in soil for sensing seismic activity.

### BACKGROUND OF THE DISCLOSURE

The sensing of seismic activity is an area of ever-growing importance with the growing need to be able to reliably emplace sensors in soil for accurate sensing. Typically, the sensing of seismic activity is accomplished by way of a sensor being emplaced in the soil such that it can sense subterranean vibrations through pressures waves traveling through the ground. The key to such sensing of seismic activity is the ability to emplace a sensor properly in the soil so that it's not damaged during installation and that it's properly coupled to the surrounding soil so to accurately sense the subterranean activity. There are various known ways of emplacing sensors in the ground today such as, for example, emplacing temporary seismic sensors in vertical seismic profiling (VSP) applications wherein a clamping device is used to couple geophones to the interior of vertical well pipes. Another example is the emplacement of hydrophones in flooded vertical well pipes. Overall, the majority of permanent deep hydrophone or geophone sensor emplacements performed today in the industry use either vertical boreholes or deep trenches.

However, deep trenches often times result in the formation of voids, gaps and other cavities around the sensor which all serve to degrade the sensitivity and overall accuracy of the system. Further, open trench excavation is often times too disruptive to the surrounding area and is, hence, not preferred in many applications. Typically, open trench excavation is better suited for applications where space is limited and/or the required depth of the sensor emplacement is fairly shallow such as, for example, with depths ranging from several feet to 20 feet.

On the other hand, trenchless technologies are also known and used today as an alternative to open trench excavation. Trenchless technologies are such that create a borepath into which a sensor (or a sensor array) can be inserted. One form of trenchless technology is known as horizontal directional drilling (HDD). HDD is a steerable trenchless technology for installing underground pipes, conduits and cables in a shallow arc along a prescribed borepath by using drilling pipe launched from surface drilling rigs. HDD presents a minimal impact on the surrounding area. HDD is a typical approach taken when digging open trenches is impractical or the depth of the required emplacement is too deep. It is suitable for a variety of soil conditions and jobs including road, landscape and river crossings. Installation lengths up to 6,500′ (2,000 m) have been completed, and diameters up to 56″ (1,200 mm) have been installed in shorter runs. Pipes placed in the borepath can be made of various materials such as PVC, polyethylene, ductile iron, and steel if the pipes have the tensile strength to be pulled through the borepath.

The HDD drilling begins with first viewing the geological surroundings to see if HDD is a viable option. HDD is not favored when there are voids in the rock or incomplete layers of rock. The best material is solid rock, sedimentary material, or consolidated soils. However, trenchless technologies such as HDD also have a number of limitations and shortcomings. For example, HDD requires the use of very rugged sensors in order for the sensors to be reliably pulled through a borepath. Further, HDD has typically exhibited an inherent limited ability to effectively couple the sensor to the walls of the borepath and, hence, has exhibited poor performance at times. Further, sensors can be damaged during installation when using HDD methods by the significant pressures placed on the sensor (or the sensor array) by the borepath itself as the sensor is pulled through the borepath into place.

The sensors typically used in HDD applications for sensing seismic activity are in the form of one or more hydrophones or geophones aligned in an array placed within the borepath. However, due to their fragile nature and critical coupling requirements, difficulties often arise with their use in HDD applications.

Accordingly, there exists a long felt need for an improved method for the emplacement of a sensor in soil for sensing seismic activity that overcomes and alleviates the inherent problems known with the sensor emplacement methods currently being employed in the seismic sensing industry today.

### SUMMARY OF THE DISCLOSURE

According to one embodiment of the present disclosure, a method for the emplacement of a sensor in soil for sensing seismic activity is presented having a series of steps that comprise using a drillstring pipe to create a borepath having opposing ends, attaching a reamer to the drillstring pipe and pulling it back through the borepath to enlarge the diameter of the borepath, pulling a longitudinal housing and a grout pipe into the borepath extending from one opposing end to the other and with the longitudinal housing having a sensor encapsulated within, anchoring the longitudinal housing at one of the opposing ends, pulling the grout pipe longitudinally within the borepath to position its grouting end within the borepath between the opposing ends, and conducting a grout through the grout pipe into the borepath at the grouting end while continuing to pull the grout pipe through the borepath until the grouting end is positioned adjacent to one opposing end to encase the longitudinal housing within the borepath thereby facilitating emplacement of a sensor in soil for sensing seismic activity. Emplacement of a sensor in accordance with the teachings of the present disclosure may serve to alleviate some of the pressures that are otherwise exerted on the sensor when filling the borepath with grout. Further, the voids and gaps that might otherwise form around the longitudinal housing conventional methodologies may be substantially avoided using the emplacement method as taught by the present disclosure.

In one embodiment of the present disclosure, multiple grout pipes may also be used to conduct the grout into the borepath for encasing the sensor. Using multiple grout pipes provides for even more relief of the pressures felt by the sensor due to less grout needing to be pushed through the borepath from a single point. The use of multiple grout pipes also provides for improved grout coverage of the longitudinal housing.

Accordingly, some embodiments of the disclosure may provide numerous technical advantages. Some embodiments may benefit from some, none or all of these advantages. For example, a technical advantage of one embodiment of the disclosure may be improved sensor coupling to the soil. Furthermore, improved sensor coupling will result in higher sensor sensitivity and accuracy. Another embodiment may provide for an alternative grouting method that may provide even further benefit with regard to pressures seen at the sensor within the borepath.

Another example of a potential technical advantage of one embodiment of the present disclosure is that it may alleviate some of the inherent problems associated with the emplacement of sensor arrays regarding difficulties in maintaining proper sensor spacing within the borepath. For example, a technical advantage of one embodiment of the disclosure may be that the entire sensor array may be wholly contained and fixed in a position within a longitudinal housing before being installed in a borepath.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description. The foregoing has outlined rather broadly some of the more pertinent and important advantages of the present disclosure in order that the detailed description of the disclosure that follows may be better understood so that the present contribution to the art can be more fully appreciated. It should be appreciated by those skilled in the art that the conception and the specific embodiment disclosed may be readily utilized as a basis for modifying or designing other structures for carrying out the same purposes of the present disclosure. It should also be realized by those skilled in the art that such equivalent constructions do not depart from the spirit and scope of the present disclosure as set forth in the appended claims.

### BRIEF DESCRIPTION OF THE DRAWINGS

For a fuller understanding of the nature and possible advantages of the present disclosure, reference should be had to the following detailed description taken in connection with the accompanying drawings in which:

FIG. 1 is a pictorial representation of the general setup of a horizontal directional drilling system used to create a borepath in accordance with the teachings of the present disclosure;

FIG. 2 is a pictorial representation of the completed initial pass of the drillstring pipe cutting through the soil;

FIG. 3 is a pictorial representation illustrating the use of a reamer for enlarging the diameter of the completed borepath of FIG. 2 in accordance with the teachings of the present disclosure;

FIG. 4 is a pictorial representation of the completed enlarged borepath of FIG. 3 after having had several passes of a reamer through the borepath to enlarge the borepath diameter;

FIG. 5 is a pictorial representation illustrating a reamer, a longitudinal housing and a grout pipe being pulled through the borepath in soil;

FIG. 6 is a cross sectional view of an emplaced sensor within a borepath in accordance with the teachings of the present disclosure;

FIG. 7 is a flowchart showing one embodiment of a series of steps that may be performed for the emplacement of a sensor in soil for sensing seismic activity in accordance with the teachings of the present disclosure;

FIG. 8 is a flowchart showing another embodiment of a series of steps that may be performed for the emplacement of a sensor in soil for sensing seismic activity that makes use of a plurality of grout pipes in accordance with the teachings of the present disclosure;

FIG. 9 is a flowchart showing yet another embodiment of a series of steps that may be performed for the emplacement of a sensor in soil for sensing seismic activity that makes use of at least two grout pipes and an alternative grouting procedure in accordance with the teachings of the present disclosure;

FIG. 10 is a flowchart showing yet another embodiment of a series of steps that may be performed for the emplacement of a sensor in soil for sensing seismic activity that makes use of first and second drillstring pipes in accordance with the teachings of the present disclosure; and

FIG. 11 is a flowchart showing yet another embodiment of a series of steps that may be performed for the emplacement of a sensor in soil for sensing seismic activity that makes use of a longitudinal housing having open ends and a mule tape in accordance with the teachings of the present disclosure.

Similar reference characters refer to similar parts throughout the several views of the drawings.

### DETAILED DESCRIPTION OF THE EXAMPLE EMBODIMENTS

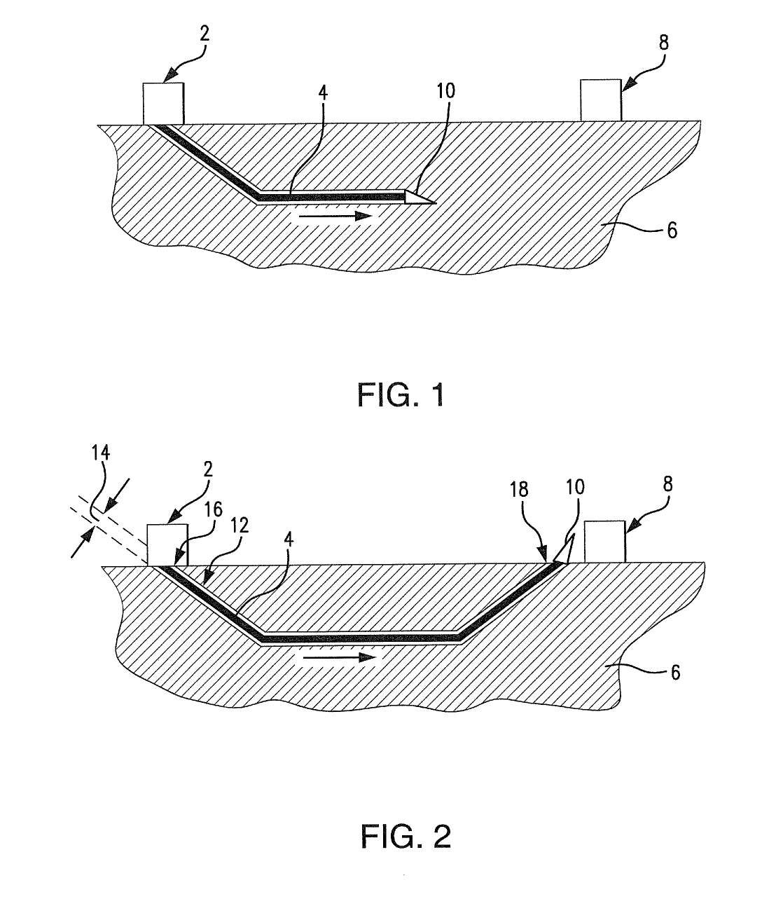

Referring now to FIG. 1, a pictorial representation can be seen of the general setup of a horizontal directional drilling system used to create a borepath in accordance with the teachings of the present disclosure. A first drilling rig 2 can be seen initiating the pushing of a drillstring pipe 4 through the soil 6 towards a second drilling rig 8 positioned a distance away from the first drilling rig 2. The drillstring pipe 4 is shown having a steerable cutting head 10 attached to lead the drillstring pipe 4 through the soil 6 in the direction of the second drilling rig 8.

In referring now to FIG. 2, a pictorial representation can be seen of the completed initial pass of the drillstring pipe 4 cutting through and emerging from the soil 6 at the second drilling rig 8. In general, the initial cutting pass of the drillstring pipe 4 is typically performed with a drillstring pipe 4 having a diameter that is suitable for an initial cutting pass and taking into account the nature of the soil 6 to penetrate. With the initial cutting pass complete and the drillstring pipe 4 now extending the entire length from the first drilling rig 2 to the second drilling rig 8, the borepath 12 has been established. The borepath 12 is defined by a diameter 14 and opposing ends 16 and 18. The next phase in standard horizontal directional drilling (HDD) is to enlarge the borepath 12 so to better receive other pipes and material being pulled through.

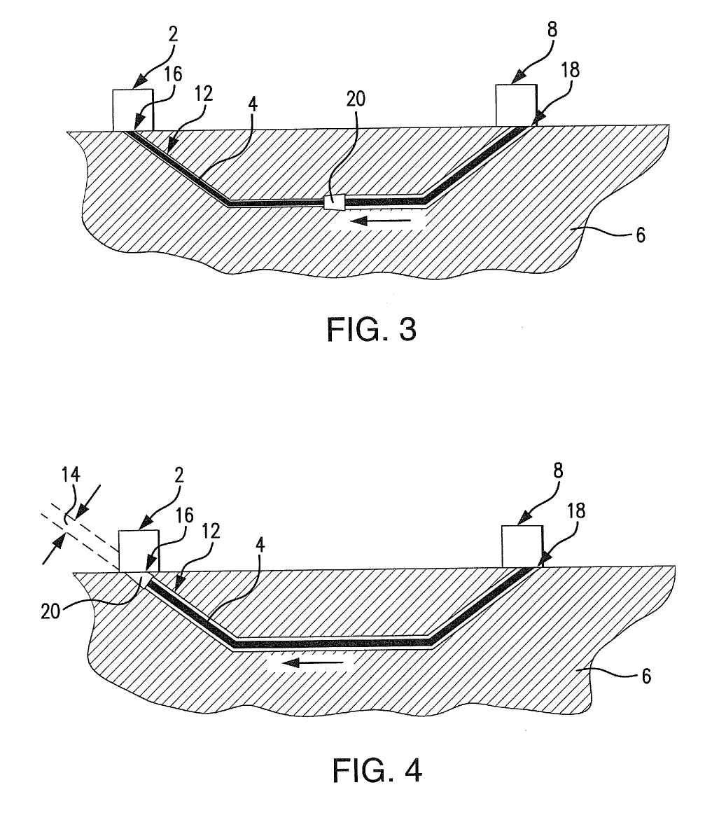

In referring now to FIG. 3, the drillstring 4 can be seen being pulled back through the borepath 12 with a reamer 20 attached to the drillstring 4. The reamer 20 serves to forcibly enlarge the diameter 14 of the borepath 12 as the drillstring 4 is pulled back towards the first drilling rig 2. During this process, additional sections of drillstring pipe 4 are added on at the second drilling rig 8 as the drillstring pipe 4 is pulled back toward the first drilling rig 2 in order to maintain the drillstring pipe 4 extending the entire length of the borepath 12. The borepath 12 now has a larger diameter 14. This process can be repeated as necessary with larger reamers to achieve a diameter 14 that is suitable for the particular application at hand.

In referring now to FIG. 4, a pictorial representation can be seen of the completed borepath 12 initiated in FIG. 3 after having had several passes of the reamer 20 performed. The diameter 14 is now enlarged to extent that the borepath 12 is better suited for receiving other pipes and materials pulled through by the drillstring pipe 4.

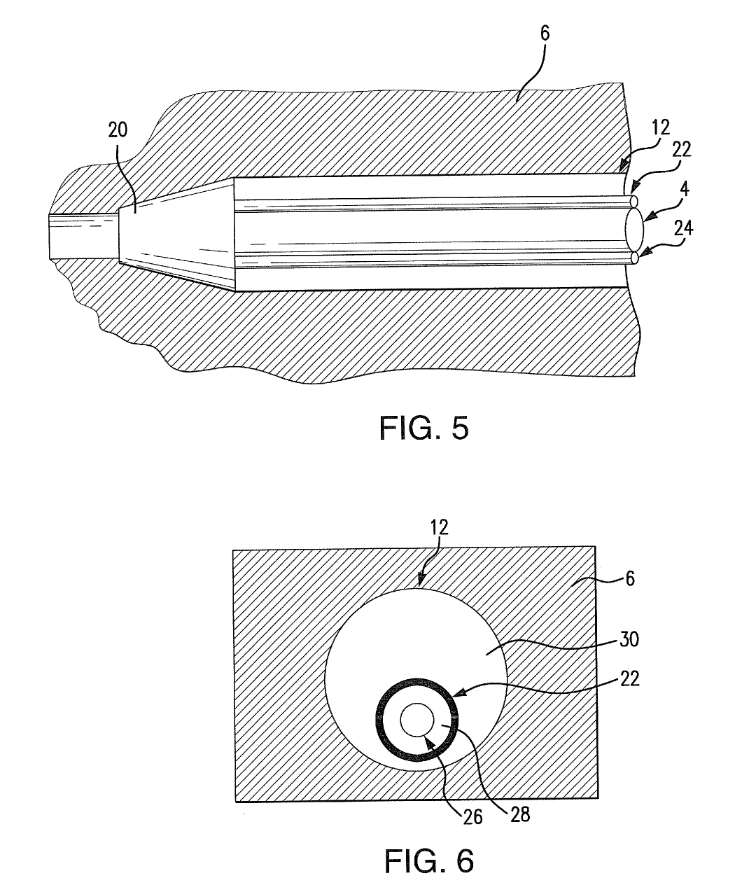

In referring now to FIGS. 5 and 6, the drillstring pipe 4 can be seen with the reamer 20 attached as it is pulled through the borepath 12 to enlarge the diameter 14. FIG. 5 further shows a longitudinal housing 22 and a grout pipe 24 having one end and a grouting end being pulled into the borepath 12 in accordance with the teachings of one embodiment of the present disclosure. In FIG. 6, a cross sectional view of a sensor 26 encapsulated within the longitudinal housing 22 emplaced within the borepath 12 in accordance with the teachings of the present disclosure. The sensor 26 is encapsulated within the longitudinal housing 22 and surrounded by a material 28 that acoustically matches and couples the sensor 26 to the longitudinal housing 22. The material 28 is preferably in the form of a low viscosity fluid such as water, silicone oil or the like and is selected for its acoustical properties for acoustically matching and coupling the sensor 26 to the longitudinal housing 22. However, in other embodiments the material 28 may also be in the form of low viscosity uncured polyurethane potting material. The sensor 26 in one embodiment may be in the form of one or more hydrophones that are commonly known and used in the seismic sensing industry today. Yet in another embodiment, the sensor 26 may be in the form of one or more geophones that are commonly known and used in the seismic sensing industry today.

The longitudinal housing 22 in one embodiment is in the form of flexible pipe made from High-Density-Polyethylene (HDPE). HDPE pipe is preferable for many applications in that it has acoustical properties very similar to that of the surrounding soil 6. The longitudinal housing 22 which encapsulates the sensor 26 surrounded by the material 28 is further acoustically matched to the surrounding soil 6 by grout 30 which encases the longitudinal housing 22 within the borepath 12. The grout 30 serves to completely surround the longitudinal housing 22 and cure to securely fix the longitudinal housing 22 in place within the borepath 12. The grout 30 in one embodiment is preferably formed of a mixture of water, Portland cement and bentonite, the ratios of which are varied depending on the nature of the soil 6 that is to be acoustically matched. Further, the grout 30 has expansive properties such that it expands while curing in the borepath 12 to promote a reliable coupling between the longitudinal housing 22 and the surrounding soil 6. The relative expansiveness of the grout 30 can be controlled by the ratio of bentonite to water as well as by the type of bentonite used (i.e., granular versus powder).

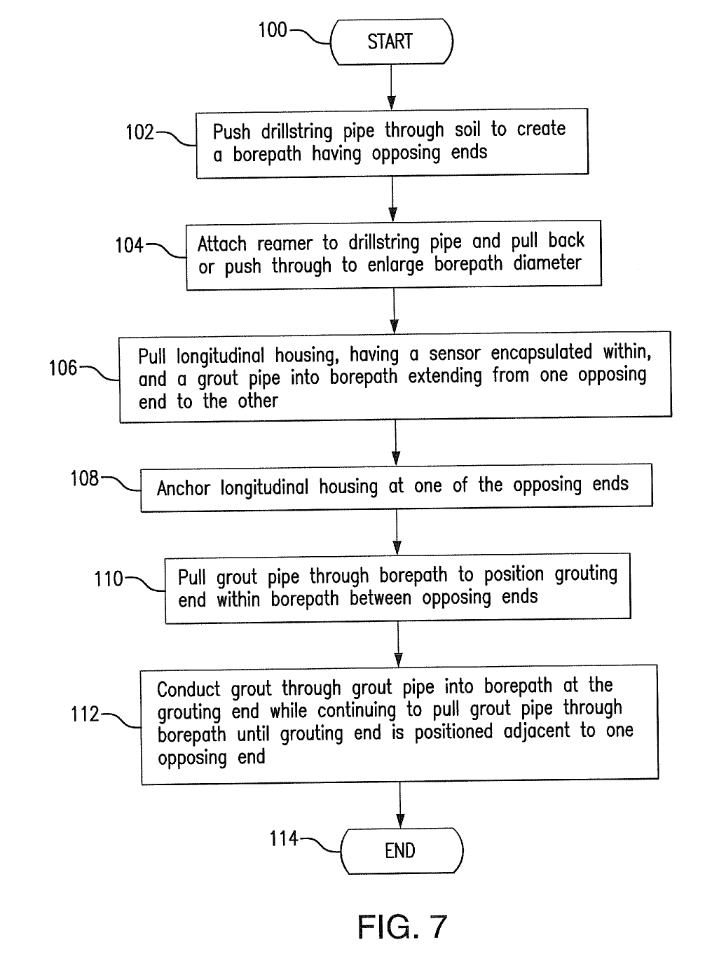

In referring now to FIG. 7, a flowchart showing one embodiment of a series of steps in a process that may be performed for the emplacement of a sensor 26 in soil 6 for sensing seismic activity in accordance with the teachings of the present disclosure can be seen. At step 100, the process starts and proceeds to step 102. At step 102, the drillstring pipe 4 is pushed through the soil 6 to create a borepath 12 having opposing ends 16 and 18. From step 102, the process moves to step 104. At step 104, a reamer 20 is attached to the drillstring pipe 4 and pulled back through the borepath 12 to enlarge the diameter 14 of the borepath 12. From step 104, the process moves to step 106. At step 106, a longitudinal housing 22 and a grout pipe 24 are attached to the drillstring pipe 4 and pulled into the borepath 12 extending from one opposing end 16 to the other 18. The longitudinal housing 22 includes a sensor 26 surrounded by material 28 encapsulated within it. From step 106, the process moves to step 108. At step 108, the longitudinal housing 22 is anchored at one of the opposing ends 16 and 18. From step 108, the process moves to step 110.

At step 110, the grout pipe 24 is pulled through the borepath 12 to position the grouting end within the borepath 12 between the opposing ends 16 and 18. From step 110, the process moves to step 112. At step 112, grout 30 is conducted through the grout pipe 24 into the borepath 12 at the grouting end while continuing to be pulled longitudinally through the borepath 12 until the grouting end is positioned adjacent to one opposing end of the borepath 12. At this point, the emplacement of the sensor 26 within the soil 6 is complete with the acoustically matched grout 30 left to expand and cure within the borepath 12. From step 112, the process moves to step 114 where the process ends.

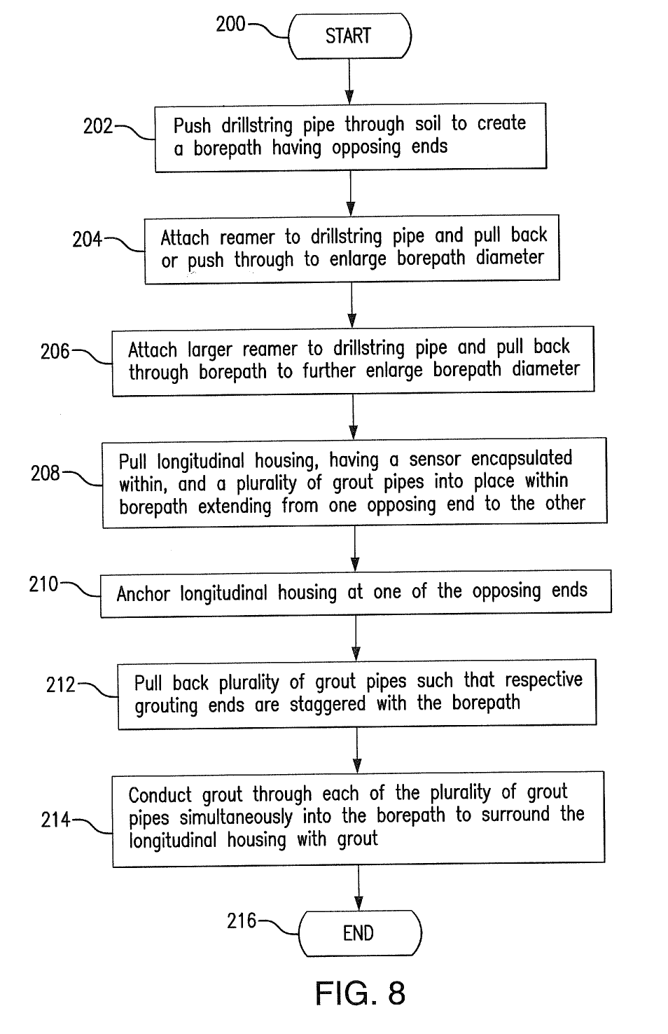

In referring now to FIG. 8, a flowchart showing another embodiment of a series of steps of a process that may be performed for the emplacement of a sensor 26 in soil 6 for sensing seismic activity that makes use of a plurality of grout pipes 24 in accordance with the teachings of the present disclosure. The process starts at step 200 and moves to step 202. At step 202, the drillstring pipe 4 is pushed through the soil 6 to create a borepath 12 having opposing ends 16 and 18. From step 202, the process moves to step 204. At step 204, a reamer 20 is attached to the drillstring pipe 4 and pulled back through the borepath 12 to enlarge the diameter 14 of the borepath 12. From step 204, the process moves to step 206. At step 206, another reamer 20 of a larger size is attached to the drillstring pipe 4 and pulled back through the borepath 12 to further enlarge the diameter 14 of the borepath 12 so to accommodate the pulling of additional materials through the borepath 12.

From step 206, the process moves to step 208. At step 208, a longitudinal housing 22 and a plurality of grout pipes 24 are attached to the drillstring pipe 4 and pulled into the borepath 12 extending from one opposing end 16 to the other opposing end 18. The longitudinal housing 22 includes a sensor 26 surrounded by material 28 encapsulated within it. In one embodiment, the plurality of grout pipes 24 may comprise three grout pipes 24. From step 208, the process moves to step 210. At step 210, the longitudinal housing 22 is anchored at one of the opposing ends 16 and 18. From step 210, the process moves to step 212. At step 212, the plurality of grout pipes 24 are pulled back longitudinally through the borepath 12 to the extent that their respective grouting ends are staggered within the borepath 12. From step 212, the process moves to step 214. At step 214, grout 30 is conducted through the plurality of grout pipes 24 simultaneously into the borepath 12 at the grouting ends until the borepath 12 is full of grout 30. The plurality of grout pipes 24 are left grouted in place within the borepath 12. At this point, the emplacement of the sensor 26 within the soil 6 is complete with the acoustically matched grout 30 left to expand and cure within the borepath 12 in accordance with the teachings of one embodiment of the present disclosure. From step 214, the process moves to step 216 where the process ends.

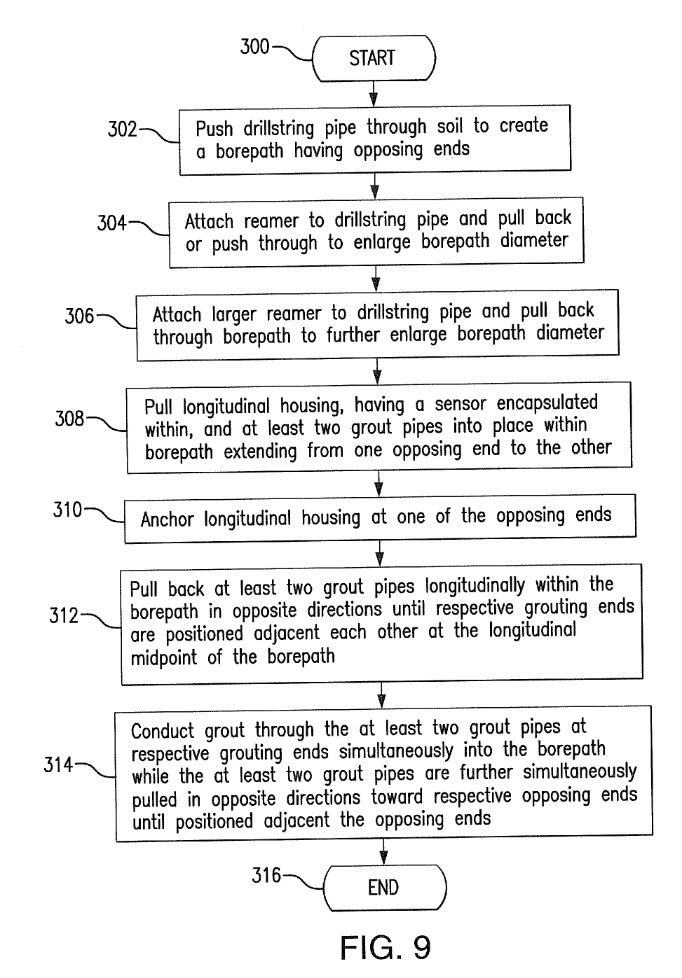

In referring now to FIG. 9, a flowchart showing yet another embodiment of a series of steps in a process that may be performed for the emplacement of a sensor 26 in soil 6 for sensing seismic activity that makes use of at least two grout pipes 24 and an novel grouting procedure in accordance with the teachings of the present disclosure. The process starts at step 300 and then moves to step 302. At step 302, the drillstring pipe 4 is pushed through the soil 6 to create a borepath 12 having opposing ends 16 and 18. From step 302, the process moves to step 304. At step 304, a reamer 20 is attached to the drillstring pipe 4 and pulled back through the borepath 12 to enlarge the diameter 14 of the borepath 12. From step 304, the process moves to step 306. At step 306, another reamer 20 of a larger size is attached to the drillstring pipe 4 and pulled back through the borepath 12 to further enlarge the diameter 14 of the borepath 12 so to accommodate the pulling of additional materials through the borepath 12.

From step 306, the process moves to step 308. At step 308, a longitudinal housing 22 and at least two grout pipes 24 are attached to the drillstring pipe 4 and pulled into the borepath 12 extending from one opposing end 16 to the other opposing end 18. The longitudinal housing 22 includes a sensor 26 surrounded by material 28 encapsulated within it. From step 308, the process moves to step 310. At step 310, the longitudinal housing 22 is anchored at one of the opposing ends 16 and 18. From step 310, the process moves to step 312. At step 312, the at least two grout pipes 24 are pulled back longitudinally through the borepath 12 in opposite directions until respective grouting ends of the grout pipes 24 are positioned adjacent each other at the longitudinal midpoint of the borepath 12.

From step 312, the process moves to step 314. At step 314, grout 30 is conducted through the at least two grout pipes 24 simultaneously into the borepath 12 at the grouting ends while the at least two grout pipes 24 are further simultaneously pulled in opposite directions toward respective opposing ends 16 and 18 of the borepath 12 until positioned adjacent the opposing ends 16 and 18. At this point, the emplacement of the sensor 26 within the soil 6 is complete with the acoustically matched grout 30 left to expand and cure within the borepath 12 in accordance with the teachings of one embodiment of the present disclosure. From step 314, the process moves to step 316 where the process ends.

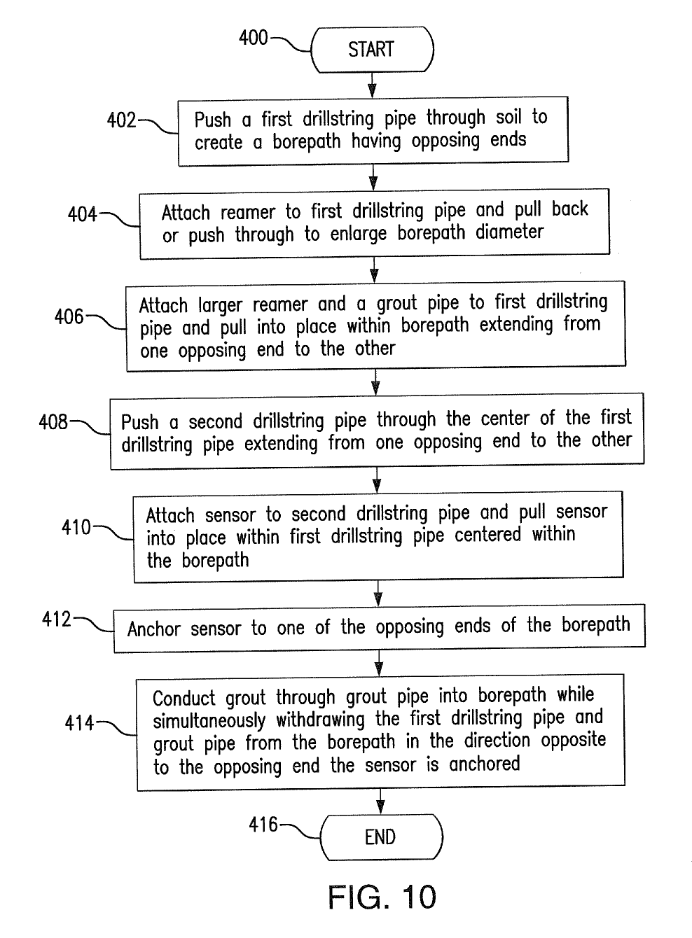

In referring now to FIG. 10, a flowchart showing yet another embodiment of a series of steps of a process that may be performed for the emplacement of a sensor 26 in soil 6 for sensing seismic activity that makes use of first and second drillstring pipes in accordance with the teachings of the present disclosure. The process starts at step 400 and moves to step 402. At step 402, a first drillstring pipe is pushed through the soil 6 to create a borepath 12 having opposing ends 16 and 18. From step 402, the process moves on to step 404. At step 404, a reamer 20 is attached to the first drillstring pipe and pulled back through the borepath 12 to enlarge the diameter 14 of the borepath 12. From step 404, the process moves to step 406.

At step 406, another reamer 20 of a larger size and a grout pipe 24 are attached to the first drillstring pipe and pulled back through the borepath 12 to further enlarge the diameter 14 of the borepath 12 so to accommodate the pulling of additional materials through the borepath 12. From step 406, the process moves to step 408. At step 408, a second drillstring pipe that is smaller in size to the first drillstring pipe is pushed longitudinally through the center of the first drillstring pipe extending from one opposing end of the borepath 12 to the other. From step, 408, the process moves on to step 410. At step 410, a sensor 26 is attached to the second drillstring pipe and then pulled longitudinally through the center of the first drillstring pipe until centered in the first drillstring pipe and centered within the borepath 12. It should be understood, however, that steps 408 and 410 could alternatively use a mule tape, a wire, a rope or other similar devise in place of the second drillstring pipe to pull the sensor 26 into the first drillstring pipe.

From step 410, the process moves on to step 412. At step 412, the sensor is anchored to one of the opposing ends 16 and 18 of the borepath 12. From step 412, the process moves on to step 414. At step 414, grout 30 is conducted through the grout pipe 24 into the borepath 12 while simultaneously withdrawing the first drillstring pipe and the grout pipe 24 from the borepath 12 in the direction opposite to the opposing end 16 or 18 where the sensor 26 is anchored. At this point, the emplacement of the sensor 26 within the soil 6 is complete with the acoustically matched grout 30 left to expand and cure within the borepath 12 in accordance with the teachings of one embodiment of the present disclosure. From step 414, the process moves on to step 416 where the process ends.

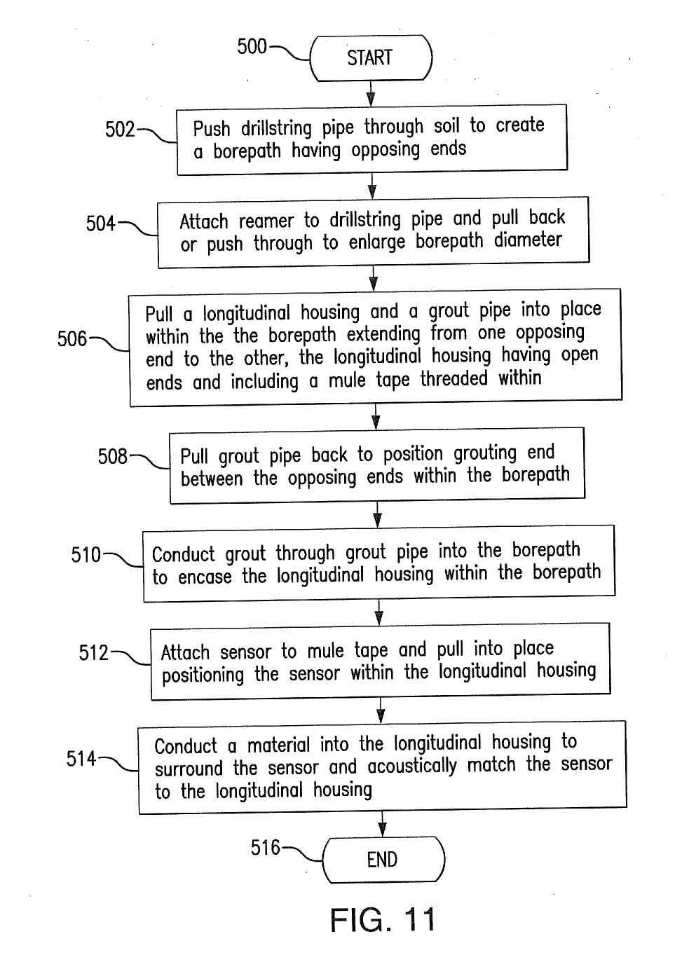

In referring now to FIG. 11, a flowchart showing yet another embodiment of a series of steps in a process that may be performed for the emplacement of a sensor 26 in soil 6 for sensing seismic activity that makes use of a longitudinal housing having open ends and a mule tape in accordance with the teachings of the present disclosure. The process starts at step 500 and then moves to step 502. At step 502, the drillstring pipe 4 is pushed through the soil 6 to create a borepath 12 having opposing ends 16 and 18. From step 502, the process moves to step 504. At step 504, a reamer 20 is attached to the drillstring pipe 4 and pulled back through the borepath 12 to enlarge the diameter 14 of the borepath 12. From step 504, the process moves to step 506. At step 506, a longitudinal housing and a grout pipe 24 are attached to the drillstring pipe 4 and pulled into place within the borepath 12 extending from one opposing end 16 to the other opposing end 18. The longitudinal housing having open ends and including a mule tape threaded within.

From step 506, the process moves to step 508. At step 508, the grout pipe 24 is pulled back longitudinally through the borepath 12 so to position the grouting end within the borepath 12 between the opposing ends 16 and 18. From step 508, the process moves on to step 510. At step 510, grout 30 is conducted through the grout pipe 24 into the borepath 12 to encase and fixedly secure the longitudinal housing within the borepath 12. From step 510, the process moves on to step 512. At step 512, the sensor 26 is attached to the mule tape and pulled into place by the mule tape positioning the sensor 26 within the longitudinal housing. From step 512, the process moves on to step 514. At step 514, a material 28 is conducted into the longitudinal housing to surround the sensor 26 and acoustically match and couple the sensor 26 to the longitudinal housing. The longitudinal housing is then sealed to retain the material 28 within. At this point, the emplacement of the sensor 26 within the soil 6 is complete with the acoustically matched grout 30 left to expand and cure within the borepath 12 in accordance with the teachings of one embodiment of the present disclosure. From step 514, the process moves to step 516 where the process ends.

The present disclosure includes that contained in the appended claims, as well as that of the foregoing description. Although this disclosure has been described in its preferred form in terms of certain embodiments with a certain degree of particularity, alterations and permutations of these embodiments will be apparent to those skilled in the art. Accordingly, it is understood that the above descriptions of exemplary embodiments does not define or constrain this disclosure, and that the present disclosure of the preferred form has been made only by way of example and that numerous changes, substitutions, and alterations in the details of construction and the combination and arrangement of parts may be resorted to without departing from the spirit and scope of the invention.

What is claimed is:

1. A method for the emplacement of a sensor in soil for sensing seismic activity, the method comprising the steps of:
creating a borepath in the soil, the borepath having opposing ends and a diameter;
inserting a longitudinal housing and a grout pipe into said borepath extending from one of said opposing ends to the other, said longitudinal housing having the sensor encapsulated within, said grout pipe having one end and a grouting end;
pulling said grout pipe longitudinally within said borepath by said one end to position said grouting end between said opposing ends within said borepath; and
conducting a grout through said grout pipe into said borepath at said grouting end to encase said longitudinal housing within said borepath thereby facilitating emplacement of a sensor in soil for sensing seismic activity.

2. The method of claim 1, wherein the step of pulling said grout pipe longitudinally within said borepath and the step of conducting a grout through said grout pipe into said borepath are performed simultaneously and continually until said grouting end of said grout pipe is positioned adjacent to one of said opposing ends of said borepath.

3. The method of claim 2, wherein said longitudinal housing further includes a material encapsulated within for surrounding the sensor and acoustically matching the sensor to said longitudinal housing and wherein the step of conducting grout through said grout pipe into said borepath further comprises the step of initially selecting said grout to acoustically match said longitudinal housing to the soil.

4. The method of claim 3, wherein said longitudinal housing is in the form of high-density-polyethylene (HDPE) pipe and said sensor is comprised of at least one hydrophone.

5. The method of claim 4, wherein the step of creating a borepath is comprised of first pushing a drillstring pipe through the soil and then further pulling or pushing a reamer through said borepath to enlarge said diameter of said borepath.

6. The method of claim 1, wherein said grout pipe is in the form of a plurality of grout pipes each having respective one ends and grouting ends, and wherein the step of pulling said grout pipe longitudinally within said borepath is comprised of pulling each of said plurality of grout pipes longitudinally within said borepath such that said respective grouting ends of said plurality of grout pipes are staggered within the borepath.

7. The method of claim 6, wherein the step of conducting grout through said grout pipe into said borepath is comprised of conducting grout through each of said plurality of grout pipes simultaneously.

8. The method of claim 7, wherein said longitudinal housing further includes a material encapsulated within for surrounding the sensor and acoustically matching the sensor to said longitudinal housing and wherein conducting grout through each of said plurality of grout pipes simultaneously further comprises the step of initially selecting said grout to acoustically match said longitudinal housing to the soil.

9. The method of claim 8, wherein said longitudinal housing is in the form of high-density-polyethylene (HDPE) pipe and said sensor is comprised of at least one hydrophone.

10. The method of claim 9, wherein the step of creating a borepath is comprised of first pushing a drillstring pipe through the soil and then further pulling or pushing a reamer through said borepath to enlarge said diameter of said borepath.

11. The method of claim 1, wherein said grout pipe is in the form of at least two grout pipes each having respective one ends and grouting ends, and wherein the step of pulling said grout pipe longitudinally within said borepath is comprised of pulling said at least two grout pipes by said respective one ends longitudinally within the borepath in opposite directions until said respective grouting ends are positioned adjacent each other and between said opposing ends of said borepath.

12. The method of claim 11, wherein the step of conducting grout through said grout pipe into said borepath is comprised of conducting grout through each of said at least two grout pipes simultaneously into said borepath as said respective grouting ends are further simultaneously pulled away from each other towards respective said opposing ends of said borepath until positioned adjacent respective said opposing ends.

13. The method of claim 12, wherein said longitudinal housing further includes a material encapsulated within for surrounding the sensor and acoustically matching the sensor to said longitudinal housing and wherein conducting grout through each of said at least two grout pipes simultaneously further comprises the step of initially selecting said grout to acoustically match said longitudinal housing to the soil.

14. The method of claim 8, wherein said longitudinal housing is in the form of high-density-polyethylene (HDPE) pipe and said sensor is comprised of at least one hydrophone.

15. The method of claim 14, wherein the step of creating a borepath is comprised of first pushing a drillstring pipe through the soil and then further pulling or pushing a reamer through said borepath to enlarge said diameter of said borepath.

16. A method for the emplacement of a sensor in soil for sensing seismic activity, the method comprising the steps of:
creating a borepath in the soil, the borepath having opposing ends and a diameter;
inserting a longitudinal housing and a grout pipe into said borepath extending from one of said opposing ends to the other, said longitudinal housing including a mule tape threaded within and having open ends, said grout pipe having one end and a grouting end;
pulling said grout pipe longitudinally within said borepath by said one end to position said grouting end between said opposing ends within said borepath; and
conducting a grout through said grout pipe into said borepath at said grouting end to encase said longitudinal housing within said borepath;
attaching the sensor to said mule tape;
pulling said mule tape through said longitudinal housing to position the sensor within said longitudinal housing; and
conducting a material into said longitudinal housing to surround the sensor and acoustically match the sensor to said longitudinal housing thereby facilitating emplacement of a sensor in soil for sensing seismic activity.

17. The method of claim 16, wherein the step of pulling said mule tape and the sensor through said longitudinal housing further comprises pulling a filling pipe into said longitudinal housing and wherein the step of conducting a material into said longitudinal housing further comprises pulling said filling pipe back out of said longitudinal housing while simultaneously conducting said material into said longitudinal housing.

18. A method for the emplacement of a sensor in soil for sensing seismic activity, the method comprising the steps of:
pushing a first drillstring pipe through the soil to create a borepath in the soil, said borepath having opposing ends, said first drillstring pipe having a longitudinal center axis and extending from one of said opposing ends of the borepath to the other;
coupling a reamer and a grout pipe to said first drillstring pipe and pushing or pulling said first drillstring pipe, said reamer and said grout pipe simultaneously through said borepath;
inserting the sensor into said first drillstring pipe;
anchoring the sensor relative to one of said opposing ends of said borepath thereby fixedly positioning the sensor relative to said borepath; and
conducting a grout into said borepath through said grout pipe while simultaneously withdrawing said first drillstring pipe and said grout pipe from said borepath in the direction opposite to said opposing end where the sensor is anchored thereby surrounding the sensor with said grout within said borepath and resulting in the emplacement of the sensor in the soil for sensing seismic activity.

19. The method of claim 18, wherein the step of inserting the sensor into said first drillstring pipe comprises:
pushing a second drillstring pipe through said first drillstring pipe along said longitudinal center axis;
coupling the sensor to said second drillstring pipe; and
pulling said second drillstring pipe back through said first drillstring pipe to position the sensor within said first drillstring pipe.

20. The method of claim 18, wherein said first drillstring pipe includes a mule tape running longitudinally within and wherein the step of inserting the sensor into said first drillstring pipe comprises:
coupling the sensor to said mule tape; and
pulling said mule tape back through said first drillstring pipe to position the sensor within said first drillstring pipe.
